(19) United States
(12) Patent Application Publication
(10) Pub. No.: US 2022/0182396 A1
(43) Pub. Date: Jun. 9, 2022

(54) METHOD AND SYSTEM TO HANDLE FILES IN ANTIVIRUS ACTIONS

(71) Applicant: Lionic Corporation, Hsinchu (TW)

(72) Inventors: Chien-Ming CHEN, Hsinchu (TW); Ting-Chun HUANG, Hsinchu (TW); Chih-Jen CHANG, Hsinchu (TW)

(73) Assignee: Lionic Corporation, Hsinchu (TW)

(21) Appl. No.: 17/515,572

(22) Filed: Nov. 1, 2021

Related U.S. Application Data
(60) Provisional application No. 63/122,459, filed on Dec. 7, 2020.

(51) Int. Cl. H04L 29/06; G06F 16/13; G06F 16/172

(52) U.S. Cl. CPC H04L 63/145; G06F 16/172; G06F 16/137; H04L 63/1416

(57) ABSTRACT

An example method for a device to handle a file in an antivirus action has been disclosed. The method includes in response to receiving a signal indicative of having detected malware associated with the file, resetting a first session with a first client device and storing metadata associated with the file in a cache. The method further includes after having received the signal and in response to receiving a second request for the file from the first client device to establish a second session, retrieving the metadata from the cache, maintaining the second session, identifying a first part of the file based on the retrieved metadata during the second session, and performing the antivirus action to the identified first part of the file during the second session.

### CROSS-REFERENCE TO RELATED APPLICATION

The present application claims the benefit of U.S. Provisional Application No. 63/122,459 filed Dec. 7, 2020, which is incorporated herein by reference in its entirety.

### BACKGROUND

Unless otherwise indicated herein, the approaches described in this section are not prior art to the claims in this application and are not admitted to be prior art by inclusion in this section.

Some conventional antivirus mechanisms may rely on a hash value associated with a file and perform antivirus actions based on the hash value. For example, the antivirus actions may include overwriting a part of the file. FIG. 1 is a sequence diagram of a system 100 configured to overwrite a part of a file based on a hash value associated with the file.

System 100 may include client device 110, Device Under Test (DUT) 120, server 130 and cloud database 140. Server 130 is configured to provide a resource or a service. Client device 110 is configured to request for the resource or the service from server 130. DUT 120 may perform functional testing and calibration checking during its lifecycle. In addition, DUT 120 is configured to process requests originated from client device 110 and packets destined for client device 110.

For example, client device 110 is configured to send request 111 to request for a file 150 from server 130. DUT 120 is configured to receive and process request 111 and send processed request 121 to server 130. In response to receiving processed request 121, server 130 is configured to transfer file 150 to DUT 120 in packets 151, 152, 153 and 154 in sequence. In response to receiving packets 151, 152 and 153, DUT 120 is configured to forward packets 151, 152 and 153 to client device 110.

After having received packets 151, 152, 153 and 154 of file 150, DUT 120 is configured to calculate hash value 160 associated with file 150 and transmit hash value 160 to cloud database 140. Cloud database 140 stores a set of hash values associated with various types of known malware.

Cloud database 140 is configured to compare hash value 160 against hash values stored in cloud database 140 to identify whether hash value 160 matches to one of the hash values stored in cloud database 140. In response to identifying hash value 160 that matches to one of the hash values stored in cloud database 140, cloud database 140 is configured to send a detection signal 141 indicative of having detected known malware to DUT 120.

In response to having received detection signal 141, DUT 120 is configured to generate disinfected packet 154′ and send disinfected packet 154′ to client device 110. Client device 110 is then configured to restore file 150′ based on packets 151, 152, 153 and disinfected packet 154′. However, because packets 151, 152, and 153 have not been disinfected, any of these packets may still include malicious code. In other words, file 150′ is only partially disinfected and could still include malicious code, which may be executable and cause security issues.

Other conventional antivirus mechanisms may prevent a file including malware from being downloaded by a client device based on a hash value associated with the malware. FIG. 2 is a sequence diagram of a system 200 configured to prevent a file including malware from being downloaded by a client device.

System 200 may include client device 210, DUT 220, server 230 and cloud database 240. Server 230 is configured to provide a resource or a service. Client device 210 is configured to request for the resource or the service from server 230. Like DUT 120, DUT 220 is configured to process requests originated from client device 210 and packets destined for client device 210.

For example, client device 210 is configured to send request 211 to request for a file 250 from server 230. DUT 220 is configured to process request 211 and send processed request 221 to server 230. In response to receiving processed request 221, server 230 is configured to transfer file 250 to DUT 220 in packets 251, 252, 253 and 254 in sequence. In response to receiving packets 251, 252 and 253, DUT 220 is configured to forward packets 251, 252 and 253 to client device 210.

After receiving all packets 251, 252, 253 and 254 of file 250, DUT 220 is configured to calculate hash value 260 associated with file 250. DUT 220 is also configured to transmit hash value 260 to cloud database 240. Cloud database 240 stores a set of hash values associated with known malware. Cloud database 240 is configured to compare hash value 260 against hash values stored in cloud database 240 to identify whether hash value 260 matches to one of the hash values stored in cloud database 240. In response to identifying hash value 260 that matches one of the hash values stored in cloud database 240, cloud database 240 is configured to send a detection signal 241 indicative of having detected known malware to DUT 220.

In response to receiving detection signal 241, DUT 220 is configured to drop packet 254 and send a session reset interrupt 223 to client device 210, which terminates present session 213 between client device 210 and server 230. In addition, client device 210 cannot restore infected file 250, because packet 254 does not reach client device 210. Accordingly, no malware (e.g., infected file 250) can be executed at client device 210.

However, system 200 may encounter additional problems when being used in conjunction with an electronic mail protocol (e.g., POP3). Suppose file 250 is an electronic mail (email), and server 230 also sends additional emails 270 and 280 subsequent to email 250. As set forth above, client device 210 cannot process email 250, and present session 213 has been terminated. Therefore, in present session 213, client device 210 cannot process emails 250, 270 and 280.

In response to receiving the session reset interrupt 223, client device 210 may reestablish a new session 215 with DUT 220 and server 230. In new session 215, the steps set forth above are repeated. For example, client device 210 sends a new request to request for file 250 from server 230. DUT 220 processes the new request from client device and sends processed request to server 230. Server 230 transfers file 250 to DUT 220 in packets in sequence, and DUT 220 forwards packets of file 250, except the last packet (e.g., packet 254) of file 250, to client device 210. DUT 220 calculates hash value 260 after receiving all packets of file 250 and receives the detection signal indicative of having detected known malware from cloud database 240.

However, in new session 215, because email 250 includes malware, DUT 220 is still configured to drop the last packet of email 250 and send yet another session reset interrupt 225 to client device 210. Similarly, in new session 215, client device 210 still cannot process emails 250, 270 and 280. A user may need to find a way to delete infected email 250 from server 230 so that system 200 will not repeatedly reset its communication sessions with server 230.

Thus, an improved approach is needed to address at least the aforementioned issues.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 is a sequence diagram of a conventional system configured to overwrite a part of a file based on a hash value associated with the file;

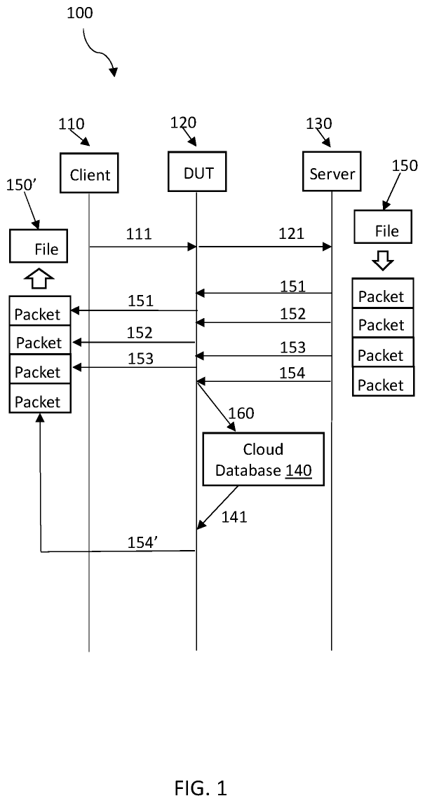

FIG. 2 is a sequence diagram of a conventional system configured to prevent a file including malware from being downloaded by a client device;

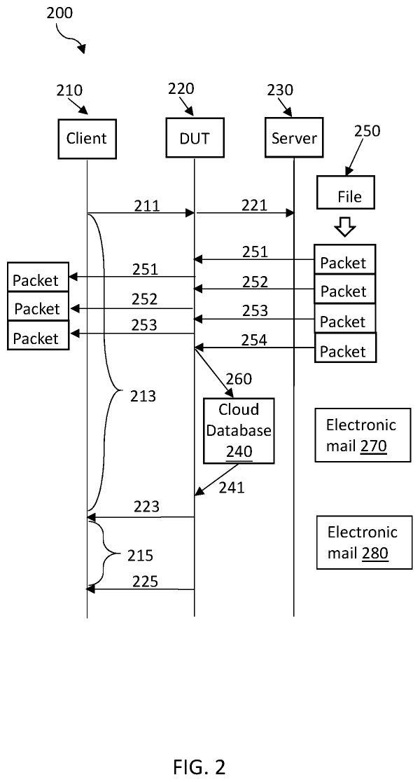

FIG. 3 is a sequence diagram of a system configured to handle a file including malware in an antivirus action, arranged in accordance with at least some embodiments of the present disclosure;

FIG. 4 is a flow diagram illustrating an example process to handle a file including malware in an antivirus action, arranged in accordance with at least some embodiments of the present disclosure; and

FIG. 5 is an example device configured to perform various embodiments of the present disclosure.

### DETAILED DESCRIPTION

The technical details set forth in the following description enable a person skilled in the art to implement one or more embodiments of the present disclosure. Throughout this disclosure, “malware” refers to any software intentionally designed to cause damages to a computer, server, client, or computer network. Some examples of malware may include, without limitation, computer viruses, worms, Trojan horses, ransomware, spyware, rogue software, wiper and scareware, etc. The term “malicious code” refers to any code in any part of software or script that is intended to cause undesired effects, security breaches or damage to a system. The term “file” refers to a digital resource for storing information and can be operated, edited, and/or transferred as a whole entity in a system. The term “session” and “communication session” can be used interchangeably and refer to an interactive information interchange between two or more communicating devices. A session is established at a certain point in time, and can be “torn down” or terminated at some later point in time. The term “antivirus action” refers to any action that addresses detected malware or malicious code in a file.

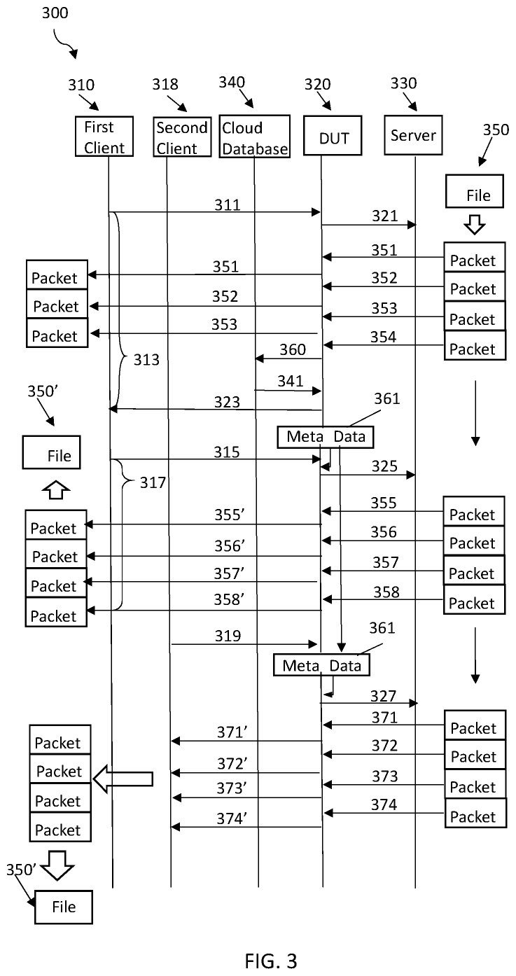

FIG. 3 is a sequence diagram of a system 300 configured to handle a file including malware in an antivirus action, arranged in accordance with at least some embodiments of the present disclosure.

In some embodiments, system 300 includes first client device 310, DUT 320, server 330 and cloud database 340. Server 330 is configured to provide a resource or a service. First client device 310 is configured to request for the resource or the service from server 330. DUT 320 is configured to process requests originated from first client device 310 and packets destined for first client device 310. In some embodiments, DUT 320 may be a security appliance configured to protect one or more networks from unwanted or undesirable traffic.

In some embodiments, first client device 310 is configured to send request 311 to request for a file 350 from server 330. In some embodiments, file 350 may be an electronic mail (email), and a software program running on first client device 310 (e.g., email client) generates and sends request 311.

DUT 320 is configured to process request 311 and send processed request 321 to server 330. In response to receiving processed request 321, server 330 is configured to transfer file 350 to DUT 320 in packets 351, 352, 353 and 354 in sequence. In response to receiving packets 351, 352 and 353, DUT 320 is configured to forward packets 351, 352 and 353 to first client device 310.

After having received packets 351, 352, 353 and 354 of file 350, DUT 320 is configured to calculate hash value 360 associated with file 350 and transmit hash value 360 to cloud database 340. Cloud database 340 stores a set of hash values associated with known malware. Cloud database 340 is configured to compare hash value 360 against hash values stored in cloud database 340 to identify whether hash value 360 matches one of the hash values stored in cloud database 340. In response to hash value 360 matching one of the hash values stored in cloud database 340, cloud database 340 is configured to send a detection signal 341 indicative of having detected known malware to DUT 320.

In some embodiments, in response to receiving detection signal 341, DUT 320 is configured to drop packet 354 and send a session reset interrupt 323 to first client device 310. In response to receiving session reset interrupt 323, first client device 310 terminates first session 313 between first client device 310 and DUT 320/server 330. Therefore, first client device 310 cannot restore infected file 350, because packet 354 is dropped by DUT 320 and does not reach first client device 310. Accordingly, no malware (e.g., infected file 350) can be executed at first client device 310.

Moreover, in the embodiments that file 350 is an email, the email client running on first client device 310 cannot process email 350 in first session 313, because packet 354 is dropped by DUT 320 and does not reach first client device 310. In some embodiments, the email client may rely on some form of “end of transmission” confirmation from server 330 to handle email 350. Thus, without the data in packet 354, the email client in first client device 310 is unable to process the partially-arrived data in packets 351, 352, and 353.

In some embodiments, DUT 320 is also configured to store metadata 361 associated with infected file 350 on DUT 320 (e.g., in a cache of DUT 320). Metadata 361 associated with file 350 may include, but not limited to, filename of file/email 350 and network information associated with file 350 (e.g., source IP address, destination IP address, source MAC address, destination MAC address, source port number, destination port number, transfer protocol related information such as host identifier, uniform resource identifiers in HTTP protocol, and parameters in POP3/SMTP protocols, and path information between the source node and the destination node etc.), subject of email 350 and sender information associated with email 350.

In some embodiments, in response to the termination of first session 313, first client device 310 is configured to reestablish a new second session 317 with DUT 320 and server 330. In some embodiments, first client device 310 is configured to send a request 315 to DUT 320 to reestablish second session 317. Here, request 315 may be a request for file 350 in its entirety. In response to receiving request 315, DUT 320 is configured to retrieve metadata 361. In addition, DUT 320 may be configured to process request 315 and send processed request 325 to server 330. In response to receiving processed request 325, server 330 is configured to transfer file 350 in its entirety to DUT 320 in packets 355, 356, 357 and 358 in sequence.

In some embodiments, in response to receiving first packet 355, DUT 320 is configured to identify the association between first packet 355 and file 350 based on retrieved metadata 361. Given that DUT 320 has been notified by cloud database 340 that file 350 is associated with known malware and has identified the association between first packet and file 350, DUT 320 is configured to, instead of sending first packet 355 to first client device 310, generate disinfected first packet 355′ and send disinfected first packet 355′ to first client device 310.

In some embodiments, in response to receiving second packet 356, DUT 320 is configured to also identify the association between second packet 356 and file 350 based on retrieved metadata 361. Like the handling of first packet 355 described above, DUT 320 is configured to, instead of sending second packet 356 to first client device 310, generate disinfected second packet 356′ and send disinfected second packet 356′ to first client device 310.

In some embodiments, in response to receiving third packet 357, DUT 320 is configured to identify the association between third packet 357 and file 350 based on retrieved metadata 361. Like the handling of first packet 355, DUT 320 is configured to, instead of sending third packet 357 to first client device 310, generate disinfected third packet 357′ and send disinfected third packet 357′ to first client device 310.

In some embodiments, in response to receiving fourth packet 358, DUT 320 is configured to identify the association between fourth packet 358 and file 350 based on retrieved metadata 361. Like the handling of first packet 355, DUT 320 is configured to, instead of sending fourth packet 358 to first client device 310, generate disinfected fourth packet 358′ and send disinfected fourth packet 358′ to first client device 310. In some embodiments, to generate disinfected first packet 355′, second packet 356′, third packet 357′, and fourth packet 358′, DUT 320 is configured to replace one or more malicious code in first packet 355, second packet 356, third packet 357, and fourth packet 358, respectively, with neutral and non-executable contents.

In some embodiments, after receiving disinfected packets 355′, 356′, 357′ and 358′, first client device 310 is then configured to restore file 350′ based on disinfected packets 355′, 356′, 357′ and 358′. Therefore, file 350′ does not include any malware and should not cause any harmful security issues for first client 310.

Alternatively, request 315 may be a request for a portion of file 350, as opposed to the entire file 350. Using Hypertext Transfer Protocol (HTTP) as an example, the email client running on first client device 310 may keep track of the packets that it has already received in first session 313 (e.g., packets 351, 352, and 353) and generate request 315 that only requests for packet 354, which may correspond to packet 358 in second session 317. In some embodiments, the “Range” field in the header of request 315 may specify the number of bytes to request from file 350 and also the range of offsets. The specified number of bytes and range of offsets may identify packet 354 in file 350.

However, to ensure that packets 351, 352, and 353, which may correspond to packets 355, 356, and 357, are also disinfected, in one embodiment, DUT 320 is configured to modify request 315 and generate request 325. Request 325 causes server 330 to send file 350 in its entirety (i.e., packets 355, 356, 357, and 358) to DUT 320. DUT 320 is configured to disinfect all the packets and send disinfected packets 355′, 356′, 357′, and 358′ to first client 310. Since first client 310 has already received some parts of file 350 (e.g., packets 351, 352, and 353), in response to receiving disinfected packet 355′, one embodiment of first client 310 is configured to recognize the retransmission of file 350 and discard the earlier-received partial file 350. This helps to prevent the partially-disinfected file 350 from possibly causing security issues.

In the embodiments that file 350 is an email, first client device 310 is able to successfully download uninfected email 350 using the aforementioned approach in second session 317. First client device 310 may be configured to notify server 330 that email 350 has been successfully downloaded. In response to receiving the notification from first client device 310, server 330 may be configured to delete infected email 350.

In some embodiments, system 300 includes one or more client devices, such as second client device 318. Second client device 318 is also configured to request for a resource or a service from server 330. DUT 320 is configured to process requests originated from second client device 318 and packets destined for second client device 318.

In some embodiments, second client device 318 is configured to send request 319 to request for infected file 350 from server 330. In response to receiving request 319, DUT 320 is configured to retrieve metadata 361. DUT 320 is configured to process request 319 and send processed request 327 to server 330. In response to receiving processed request 327, server 330 is configured to transfer file 350 to DUT 320 in packets 371, 372, 373 and 374 in sequence.

Based on metadata 361, which is stored on DUT 320, in response to receiving first packet 371, DUT 320 is configured to identify the association between the first packet 371 and infected file 350. DUT 320 is then configured to generate disinfected first packet 371′ and send disinfected first packet 371′ to first client device 310. Similarly, DUT 320 is configured to generate disinfected packets 372′, 373′ and 374′ in response to receiving packets 372, 373 and 374 based on metadata 361, respectively. Therefore, DUT 320 does not send any session reset interrupts to second client device 318. After receiving disinfected packets 371′, 372′, 373′ and 374′, second client device 318 is then configured to restore file 350′ based on disinfected packets 371′, 372′, 373′ and 374′. Therefore, file 350′ is disinfected and should not cause any harmful security issues for second client device 318.

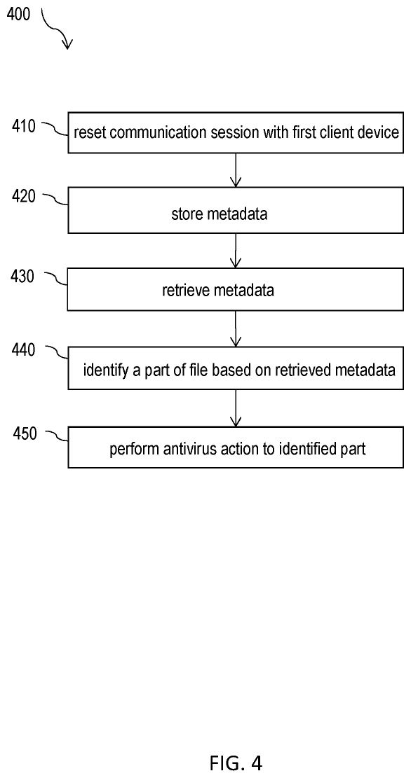

FIG. 4 is a flow diagram illustrating an example process to handle files in an antivirus action, arranged in accordance with some embodiments of the present disclosure. Process 400 may include one or more operations, functions, or actions as illustrated by blocks 410, 420, 430, 440 and/or 450 which may be performed by hardware, software and/or firmware. In some embodiments, in conjunction with FIG. 3, process 400 may be performed by DUT 320. The various blocks are not intended to be limiting to the described embodiments. The outlined steps and operations are only provided as examples, and some of the steps and operations may be optional, combined into fewer steps and operations, or expanded into additional steps and operations without detracting from the essence of the disclosed embodiments. Although the blocks are illustrated in a sequential order, these blocks may also be performed in parallel, and/or in a different order than those described herein.

Process 400 may begin at block 410, “reset communication session with first client device.” In some embodiments, referring back to FIG. 3, in response to receiving detection signal 341 indicative of having detected known malware, DUT 320 is configured to reset a session with a first client device (e.g., first client device 310) by sending the first client device a session reset interrupt (e.g., session reset interrupt 323).

Block 410 may be followed by block 420, “store metadata.” In some embodiments, DUT 320 is configured to store metadata of the file, which is associated with known malware, in its storage system (e.g., cache).

Block 420 may be followed by block 430, “retrieve metadata.” In some embodiments, referring back to FIG. 3, in response to receiving a new request (e.g., request 315) for the file from the first client device to establish a new session (e.g., second session 317), DUT 320 is configured to retrieve the stored metadata.

Block 430 may be followed by block 440, “identify a part of file based on retrieved metadata.” In some embodiments, referring back to FIG. 3, after receiving a part of the file in the new session (e.g., second session 317), DUT 320 is configured to identify the part to be associated with the file based on the retrieved metadata.

Block 440 may be followed by block 450, “perform antivirus action to identified part.” In some embodiments, given that DUT 320 has been notified that the file is associated with known malware, in response to identifying the part (e.g., packet(s)) that is associated with the file, DUT 320 is configured to perform an antivirus action to the identified part without resetting another new session with first client device 310. In some embodiments, the antivirus action may include, but not limited to, generating a disinfected version of the identified part and send this disinfected version to the first client device.

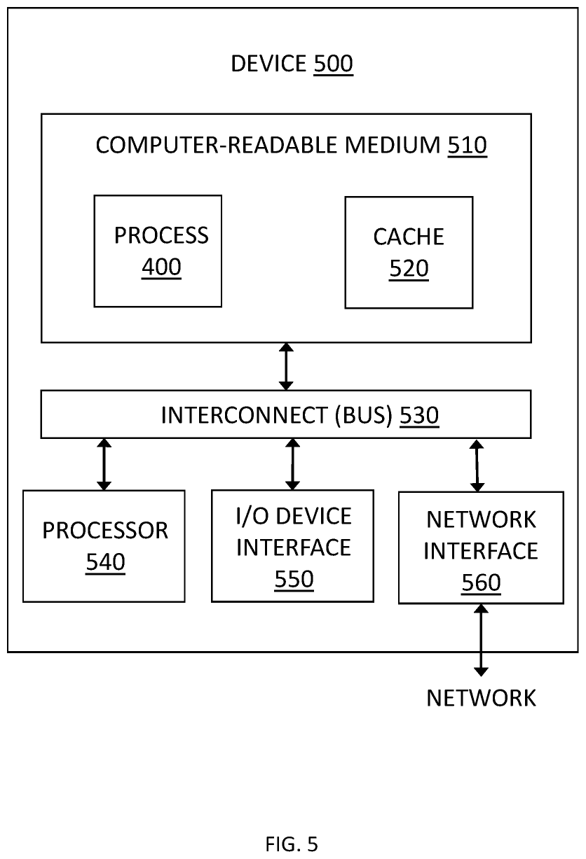

The above examples can be implemented by hardware (including hardware logic circuitry), software or firmware or a combination thereof. FIG. 5 is an example device configured to perform various embodiments of the present disclosure. For example, device 500 can be implemented as DUT 320 in FIG. 3. Device 500 may be any computing device or networking device suitable for practicing one or more embodiments of the present disclosure. In operation, device 500 is configured to execute instructions associated with process 400 as described herein. It is noted that device 500 described herein is illustrative and that any other technically feasible configurations fall within the scope of the present disclosure.

As shown, device 500 includes, without limitation, an interconnect (bus) 530 that connects at least one processor 540, computer-readable medium 510, input/output (I/O) device interface 550, and network interface 560. Processor 540 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU or digital signal processor (DSP). In general, processor 540 may be any technically feasible hardware unit capable of processing data and/or executing executable instructions, including processor 400.

Network interface 560 is configured to couple device 500 to one or more networks, so that device 500 can communicate with other devices on such network(s). For example, as shown in FIG. 3, DUT 320 communicates with first client 310, second client 318, cloud database 340, and server 330.

Processor 540, I/O device interface 550, and network interface 560 are configured to read data from and write data to computer-readable medium 510. Computer-readable medium 510 may have stored thereon instructions or program code that, in response to execution by the processor, cause the processor to perform processes described herein with reference to FIGS. 3 and 4. In some embodiments, computer-readable medium 510 includes cache 520, which can be used to store metadata, such as metadata 361.

Some aspects of the embodiments disclosed herein, in whole or in part, can be equivalently implemented in integrated circuits, as one or more programs running on one or more processors, as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium (e.g., 510) and may be executed by one or more general-purpose or special-purpose programmable microprocessors, such as processor 540. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non-recordable media (e.g., read-only memory (ROM), random access memory (RAM), magnetic disk or optical storage media, flash memory devices, etc.)

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting.

We claim:

1. A method for a device to handle a file in an antivirus action, comprising:
in response to receiving a signal indicative of having detected malware associated with the file:
resetting a first session with a first client device; and
storing metadata associated with the file in a cache; and
after having received the signal and in response to receiving a second request for the file from the first client device to establish a second session:
retrieving the metadata from the cache;
maintaining the second session;
identifying a first part of the file based on the retrieved metadata during the second session; and
performing the antivirus action to the identified first part of the file during the second session.

2. The method of claim 1, further comprising receiving a first request for the file from the first client device before resetting the first session with the first client device.

3. The method of claim 1, wherein the metadata includes one of a filename associated with the file, network information associated with the file, a subject of an electronic mail associated with the file, and sender information associated with the electronic mail associated with the file.

4. The method of claim 1, further comprising:
generating a hash value associated with the file; and
sending the hash value to a database that includes a plurality of hash values corresponding to known malware for comparison.

5. The method of claim 1, further comprising:
after performing the antivirus action to the identified first part of the file, identifying all other parts of the file based on the retrieved metadata and performing the antivirus action to the identified all other parts of the file in the second session.

6. The method of claim 1, further comprising:
in response to receiving another request for the file from a second client device to establish another session:
retrieving the metadata from the cache;
maintaining the another session;
identifying a second part of the file based on the retrieved metadata in the another session; and
performing the antivirus action to the identified second part of the file in the another session.

7. The method of claim 6, wherein the second request is for the file in its entirety or the file with a specified range.

8. The method of claim 1, wherein after having received the signal and in response to receiving the second request, further comprising:
modifying the second request to cause all parts of the file to be sent to the device for disinfection.

9. A non-transitory computer-readable storage medium that includes a set of instructions which, in response to execution by a processor of a computing device, causes the processor to perform a method to handle a file in an antivirus action, the method comprising:
in response to receiving a signal indicative of having detected malware associated with the file:
resetting a first session with a first client device; and
storing metadata associated with the file in a cache; and
after having received the signal and in response to receiving a second request for the file from the first client device to establish a second session:
retrieving the metadata from the cache;
maintaining the second session;
identifying a first part of the file based on the retrieved metadata during the second session; and
performing the antivirus action to the identified first part of the file during the second session.

10. The non-transitory computer-readable storage medium of claim 9, that includes additional instructions which, in response to execution by the processor, causes the processor to, receive a first request for the file from the first client device before resetting the first session with the first client device.

11. The non-transitory computer-readable storage medium of claim 9, wherein the metadata includes one of a filename associated with the file, network information associated with the file, a subject of an electronic mail associated with the file, and sender information associated with the electronic mail associated with the file.

12. The non-transitory computer-readable storage medium of claim 9, that includes additional instructions which, in response to execution by the processor, causes the processor to:
generate a hash value associated with the file; and
send the hash value to a database that includes a plurality of hash values corresponding to known malware for comparison.

13. The non-transitory computer-readable storage medium of claim 9, that includes additional instructions which, in response to execution by the processor, cause the processor to, after performing the antivirus action to the identified first part of the file, identify all other parts of the file based on the retrieved metadata and perform the antivirus action to all other parts of the file in the second session.

14. The non-transitory computer-readable storage medium of claim 9, that includes additional instructions which, in response to execution by the processor, causes the processor to:
in response to receiving another request for the file from a second client device to establish another session:
retrieve the metadata from the cache;
maintain the another session;
identify a second part of the file based on the retrieved metadata in the another session; and
perform the antivirus action to the identified second part of the file in the another session.

16. The non-transitory computer-readable storage medium of claim 9, wherein after having received the signal and in response to receiving the second request, the method further comprising:
modifying the second request to cause all parts of the file to be sent to the device for disinfection.

17. A device configured to handle a file in an antivirus action, comprising:
a processor; and
a non-transitory computer-readable storage medium storing executable instructions, which in response to execution by the processor, cause the processor to:
in response to receiving a signal indicative of having detected malware associated with the file:
reset a first session with a first client device; and
store metadata associated with the file in a cache; and
after having received the signal and in response to receiving a second request for the file from the first client device to establish a second session:
retrieve the metadata from the cache;
maintain the second session;
identify a first part of the file based on the retrieved metadata during the second session; and
perform the antivirus action to the identified first part of the file during the second session.

18. The device of claim 17, wherein the processor is further configured to receive a first request for the file from the first client device before resetting the session with the first client device.

19. The device of claim 17, wherein the processor is further configured to:
generate a hash value associated with the file; and
send the hash value to a database that includes a plurality of hash values corresponding to known malware for comparison.

20. The device of claim 17, wherein after having received the signal and in response to receiving the second request, the processor is further configured to modify the second request to cause all parts of the file to be sent to the device for disinfection.
